(19) United States
(12) Patent Application Publication
(10) Pub. No.: US 2016/0236177 A1
(43) Pub. Date: Aug. 18, 2016

(54) CELLULAR SOLID COMPOSITE MATERIAL COMPRISING METAL NANOPARTICLES, PREPARATION PROCESS AND USES FOR THE REVERSIBLE STORAGE OF HYDROGEN

(71) Applicants: CENTRE NATIONAL DE LA RECHERCHE SCIENTIFIQUE, Paris (FR); UNIVERSITE PIERRE ET MARIE CURIE (PARIS 6), Paris (FR)

(72) Inventors: Renal Backov, Bordeaux-Cauderan (FR); Christel Gervais, Paris (FR); Raphael Janot, Villers-Bocage (FR); Clement Sanchez, Bures Sur Yvette (FR); Martin Depardieu, Orleans (FR)

(73) Assignee: Centre National de la Recherche Scientifique, Paris (FR)

(21) Appl. No.: 15/025,764

(22) PCT Filed: Oct. 2, 2014
(86) PCT No.: PCT/FR2014/052492

§ 371 Date: Mar. 29, 2016

(30) Foreign Application Priority Data
Oct. 3, 2013 (FR) 13 59588

(51) Int. Cl. B01J 21/18; B01J 23/52; B01J 35/04; C01B 3/04; B01J 37/02; B01J 37/08; C01B 3/00; B01J 23/44; B01J 35/10

(52) U.S. Cl. CPC B01J 21/18; B01J 23/44; B01J 23/52; B01J 35/04; B01J 35/1076; B01J 35/1057; B01J 37/0201; B01J 37/0236; B01J 37/088; C01B 3/0084; C01B 3/04

(57) ABSTRACT

A macroporous monolithic composite material to a carbon monolith is provided having a hierarchized porous structure has metal nanoparticles. The arrangement also includes a process for the preparation thereof, a process for storing hydrogen that uses same, and to a process for producing gaseous hydrogen that uses such a composite material, where the process is reversible.

The present invention relates to a macroporous monolithic composite material, in particular to a carbon monolith having a hierarchized porous structure comprising metal nanoparticles, and also to the process for the preparation thereof, to a process for storing hydrogen that uses same, and to a process for producing gaseous hydrogen that uses such a composite material, said process being reversible.

Materials that are in the form of porous carbon monoliths constitute materials of choice for many applications such as purification of water and air, adsorption, heterogeneous catalysis, electrode manufacture and energy storage due to their high specific surface area, their large pore volume, their insensitivity to surrounding chemical reactions and their excellent mechanical properties.

These materials have a high specific surface area and a hierarchized structure, i.e. a cellular structure generally having dual porosity. In particular, they have a mesoporous structure in which the mean pore diameter varies from around 2 to 10 nm.

The storage and production of dihydrogen represent a current major challenge due to technological evolution and the exhausting of petroleum resources. The obsession for portable technologies is generating an increasing demand for systems that enable dihydrogen to be stored and produced in a simple and industrializabte manner.

During the last 10 years, many research studies have been undertaken to develop technologies intended to allow dihydrogen to he stored under satisfactory conditions from the point of view of both safety and use. Among such technologies, mention may especially be made of materials for high-pressure storage tanks, dihydrogen liquefaction processes and dihydrogen and metal hydride adsorption materials, these being suitable for a wide variety of both stationary and portable applications.

In particular, storing hydrogen in the solid state in the form of metal hydrides is the subject of much research since they allow pure hydrogen to be produced. Metal hydrides, especially borohydrides, furthermore have an excellent capacity (weight capacity and especially volume capacity) in terms of storing hydrogen at relatively tow pressures. Among these compounds, lithium borohydride (LiBH₄) is of particular interest due to the high hydrogen content (18.4% by weight) and its good volume capacity (121 kg·m⁻³ of H₂). The simplified reaction for decomposition of LiBH₄ is the following:

LiBH₄+B+3/2H₂

The complete release of the hydrogen contained in LiBH₄ is however difficult to obtain in so far as the thermal decomposition of the LiH formed as intermediate product during the reaction takes place at temperatures generally above 600° C. and under vacuum, which limits the amount of dihydrogen released to only 13.8% by weight.

Various tests have already been carried out for the purpose of improving the kinetics of this reaction in order to increase the amount of dihydrogen that can be released.

In particular it has been proposed to confine a metal hydride in solid form within the porosity of a macroporous/microporous carbon or ceramic monolith as described for example in patent application FR-A1-2 937 964, or else, and more recently, in macrocellular foams (Wang Z. et al., Chem. Mater., 2008, 20, 1029). However, even though the use of carbon monoliths has made it possible, by acting on the size of the microporous network, to improve the hydrogen release kinetics, it remains very difficult to carry out the rehydrogenation of the monoliths used due to the high chemical inertia of the boron, which does not make it possible to use these carbon monoliths in a reversible hydrogen storage process. Indeed, it is very difficult to overcome the chemical inertia of the boron and only the use of restrictive conditions (temperatures above 600° C., hydrogen pressure of 350 bar) has for the moment been reported in the literature (Gutowska A. et al. Angew Chem, Int. Ed., 2005, 446-447, 301). Nor, to date, is there a clearly identified catalytic species that could promote the hydrogenation of the LiH+B mixture or of alloys of Li—B type in order to result, under these acceptable temperature and pressure conditions, in LiBH₄.

The objective of the present invention is to provide a material from which it is possible to produce dihydrogen simply and reversibly at temperatures below those that are customarily needed in order to obtain a desorption of hydrogen in the form of dihydrogen from a metal borohydride and that it is furthermore possible to rehydrogenate under acceptable temperature and pressure conditions.

This objective is achieved by the composite material and the processes for the reversible storage and production of hydrogen that are the subject of the present invention and that will he described below.

Specifically, the inventors have developed a material that is in the form of a carbon monolith having an M2 (macroporous/microporous) hierarchized porous structure comprising nanoparticles of a suitably selected metal and that can be used advantageously for the storage of hydrogen by heterogeneous nucleation of a metal hydride within the porosity of said monolith, and also for producing dihydrogen by desorption of the hydrogen contained in the composite material resulting from the hydrogen storage process, said material possibly then being rehydrogenated.

A first subject of the present invention is therefore a cellular solid composite material that is in the form of a porous carbon monolith comprising a hierarchized porous network comprising macropores having a mean size d_{A} of 1 μm to 100 μm approximately, preferably of 4 to 70 μm approximately, and micropores having a mean size d_{I} of 0.7 to 1.5 nm, said macropores and micropores being interconnected, said material having no mesoporous network and being characterized in that it comprises nanoparticles of a metal M in the zero oxidation Is state, said metal M being selected from palladium and gold.

According to the invention, the nanoparticles of palladium or gold are present at the surface and within the porous network of the monolith. More specifically, the nanoparticles of palladium or gold are present at the surface of the macropores of the monolith.

According to the invention, the size of the nanoparticles of metal M may vary from 1 to 300 nm approximately. According to one preferred embodiment of the invention, the size of the nanoparticles of metal M varies from 2 to 100 nm approximately and more particularly from 2 to 20 nm approximately.

Within the context of the present invention, a monolith is understood to mean a solid object having a mean size of at least 1 mm.

Also within the context of the present invention, a mesoporous network is understood to mean a network comprising mesopores, i.e. pores having a size that varies from 2 to 50 nm.

in this material, the walls of the macropores generally have a thickness of 1 to 10 nm, and preferably of 1 to 20 nm.

According to the invention, the micropores are present in the thickness of the walls of the macropores, then rendering them microporous.

The specific surface area of the material in accordance with the invention is generally from 50 to 900 m²/g approximately, preferably from 100 to 700 m²/g approximately.

As is clearly demonstrated in the examples that illustrate the present invention, the presence of these metal nanoparticles in the carbon monoliths makes it possible to greatly improve the rehydrogenation process, thus making it possible to attain a process for the reversible storage of hydrogen at 400° C. The inventors of the present application have not yet clearly identified the mechanism which is behind this improvement, but they believe that it is not a catalyzed rehydrogenation reaction in so far as no catalytic reduction of boron by the metals has yet been reported in the literature.

Another subject of the invention is a process for preparing a composite material as described above, said process comprising the following steps:

i) a step of impregnating a porous carbon monolith comprising a hierarchized porous network comprising macropores having a mean size d_{A} of 1 μm to 100 μm approximately, preferably of 4 to 70 μm approximately, and micropores having a mean size d_{I} of 0.7 to 1.5 nm, said macropores and micropores being interconnected, said material having no mesoporous network, with a solution of a salt of a metal M selected from palladium and gold in a solvent;

ii) a step of air drying said monolith;

iii) a step of forming nanoparticles of said metal M in the zero oxidation state by heat treatment of said monolith at a temperature varying from 50 to 900° C., in the presence of a reducing gas, in order to reduce the metal ions M to the zero oxidation state.

Steps i) to iii) may of course be optionally repeated one or more times depending on the final amount of metal nanoparticles that it is desired to incorporate into the carbon monolith and on the concentration of the metal salt solution used to carry out the impregnation.

The carbon monoliths that can be used in step i) of the process in accordance with the invention (“bare” monoliths) are materials known per se and the preparation process of which is described for example in patent application FR-A 1-2 937 970.

The nature of the salts of the metal M is not critical. By way of nonlimiting example, the salts of a metal M that can be used according to the process in accordance with the invention may especially be selected from chlorides, sulphates, nitrates, phosphates, etc. Among such salts, mention may especially be made of palladium chloride, potassium tetrachloroaurate (K₂AuCl₄) and hydrogen tetrachloroaurate (HAuCl₄).

The nature of the solvent of the metal M salt solution is not critical provided that it makes it possible to dissolve said metal M. By way of nonlimiting example, the solvent of the metal M salt solution is a polar solvent selected from water, tower alcohols such as methanol and ethanol, acetone, etc., and mixtures thereof.

The concentration of metal M salt within the impregnation solution varies preferably from 10⁻³ M to 1 M and more preferably from 10⁻² to 10⁻¹ M.

Step ii) of drying the monolith is preferably carried out at a temperature of 20 to 80° C., and more preferably at ambient temperature.

The nature of the reducing gas used during step iii) of forming the nanoparticles of metal M is not critical provided that it makes it possible to reduce said metal M to the zero oxidation state. By way of nonlimiting example, the reducing gas may especially be selected from hydrogen, argon, etc., and mixtures thereof; hydrogen being particularly preferred.

According to one preferred embodiment of the invention, the heat treatment is step iii) is carried out at a temperature of 80 to 400° C. approximately.

According to one particularly preferred embodiment of the invention, the heat treatment of step iii) is carried out in the presence of hydrogen at a temperature of 400° C. approximately, for 1 hour.

The composite material in accordance with the invention and prepared in this way can then be used for storing hydrogen.

Another subject of the invention is therefore a process for storing hydrogen in a composite material comprising nanoparticles of a metal M selected from palladium and gold in the zero oxidation state in accordance with the invention and as described above, said process being characterized in that it comprises at least the following steps:

a) a step of degassing said material under i h vacuum and at a temperature of 150 to 400° C. approximately;

b) a step of impregnating, at ambient temperature, said degassed material with a solution of at least one metal hydride of formula (I) X(BH₄), with X=Li, Na, Mg or K, and n=1 when X=Li, Na or K and n=2 when X=Mg, in solution in an organic solvent selected from ethers;

c) a step of drying the material impregnated with the metal hydride solution, said drying being carried out under tow vacuum and at ambient temperature; and optionally

d) the repetition, one or more times, of steps b) and c) above.

According to one preferred embodiment of this process, the degassing of the material during step a) is carried out at a temperature of 280 to 320° C. approximately and more preferably still at a temperature of 300° C. approximately.

The duration of step a) may vary from 2 to 24 hours approximately, it is preferably 12 hours approximately.

Formula (I) of the metal hydrides that can he used according to the invention of course encompasses lithium borohydride (Li(BH₄)), sodium borohydride (Na(BH₄)), magnesium tetrahydroborate (Mg(BH₄)₂) and potassium borohydride (K(BH₄)). Among these hydrides of formula (I), lithium borohydride is very particularly preferred.

The ether solvents that can be used during step b) may be selected from aliphatic ethers and cyclic ethers. Among the aliphatic ethers, mention may especially he made of alkyl ethers such as methyl tert-butyl ether (MTBE) or is diethyl ether. Among the cyclic ethers, mention may especially he made of tetrahydrofuran. According to one preferred embodiment of the process in accordance with the invention, the solvent of the metal hydride solution is MTBE.

The concentration of the solution of metal hydride of formula (I) used during step h) varies preferably from 0.05 to 5 M, and more preferably still from 0.1 to 0.5 M approximately.

Another subject of the invention is the composite material resulting from the hydrogen storage process in accordance with the invention and as described above.

This composite material is in the form of a porous carbon monolith comprising a hierarchized porous network comprising macropores having a mean size d_{A} of 1 μm to 100 μm approximately, preferably of 4 to 70 μm approximately, and micropores having a mean size d_{I} of 0.7 to 1.5 nm, said macropores and micropores being interconnected, said material having no mesoporous network, said composite material being characterized in that it comprises nanoparticles of a metal M in the zero oxidation state, said metal M being selected from palladium and gold, and in that the micropores contain hydrogen in the form of a crystalline, semicrystalline or amorphous metal hydride selected from the hydrides of formula (I) X(BH₄), with X=Li, Na, Mg or K, and n=1 when X=Li, Na or K and n=2 when X=Mg.

The specific surface area of the composite material in accordance with the invention is generally from 50 to 900 m²/g approximately, preferably from 100 to 700 m²/g approximately.

According to one preferred embodiment of the invention, the volume of the micropores is greater than or equal to 0.30 cm³·g⁻¹ of composite monolith and the metal hydride of formula (I) is in this case in amorphous form.

The content of hydrogen present in the form of metal hydride in the composite material in accordance with the invention will vary as a function of the microporous volume and of the specific surface area of the monolith used during the impregnation step b) and of the metal hydride concentration of the solution used for the impregnation of said monolith. Generally, the hydrogen content varies from 0.01 to 0.03 mol of hydrogen approximately per gram of monolithic carbon. This molar amount corresponds to a weight capacity of 1.8 to 5.4% approximately (weight of hydrogen stored relative to the total weight of the composite material).

One subject of the invention is the use of a composite material as defined above for the production of dihydrogen, especially for supplying dihydrogen to a fuel cell operating with dihydrogen.

Finally, one subject of the invention is the dihydrogen production process using a composite material in accordance with the present invention. It is characterized in that the composite material as defined above is subjected to a heating step at a temperature of at least 100° C. Preferably, the heating step is carried out at a temperature of 250 to 400° C.

At a temperature of at least 100° C., the release of dihydrogen is observed following the desorption of the hydrogen from the metal hydride of formula (I) contained in the micropores of the composite material in accordance with the invention.

At the end of the heating step needed for the production of dihydrogen, the composite material in accordance with the invention has the distinctive feature of being able to be rehydrogenated. In this case, the composite material is subjected to a hydrogen pressure of 50 to 200 bar at a temperature of 200 to 500° C. for 1 to 48 hours.

Thus, one subject of the invention is a reversible dihydrogen production process using a composite material that contains a metal hydride of formula (I) in accordance with the present invention and as defined above, said process being characterized in that it comprises the following steps:

1) a dihydrogen production step during which the composite material as defined above is subjected to a heating step at a temperature of at least 100° C., then

2) a rehydrogenation step during which said composite material is subjected to a hydrogen pressure of 50 to 200 bar at a temperature of 200 to 500° C. for 1 to 48 hours;

3) the repetition of steps 1) and 2) above one or more times.

According to one preferred embodiment of this process, step 2) is carried out by subjecting the material to a hydrogen pressure of 100 bar at 400° C. for 12 to 24 hours.

The present invention is illustrated by the following exemplary embodiments, to which the invention is not however limited.

### EXAMPLES

The raw materials used in the following examples are listed below:
98% pure cetyltrimethylammonium bromide (CTAB): from ChemPur;
tetraethoxyorthosilane (TEOS), purity >99%: from Sigma-Aldrich;
palladium chloride (PdCl₂) and potassium tetrachloroaurate (KAuCL₄): from Sigma-Aldrich;
acetone and dodecane, purity 90%: from Rectapur;
tetrahydrofuran (THF);
37% hydrochloric acid; 50% hydrofluoric acid: from Carlo Erba Reagents;
phenol-formaldehyde resin sold in the form of an aqueous-alcoholic solution of prepolymers, under the name Ablaphene® RS 101 by Rhodia;
commercial Li BH₄ powder sold by Acros Organics;
99.8% pure methyl tert-butyl ether (MTBE) sold by Sigma-Aldrich.

These raw materials were used as received from the manufacturers, without additional purification.

The various monoliths obtained in the examples were characterized on various size scales.

The macroporosity was characterized qualitatively by a scanning electron microscopy (SEM) technique using a Hitachi TM-1000 scanning microscope operating at 15 kV. The samples were coated with gold and palladium in a vacuum evaporator before the characterization thereof.

The mesoporosity was characterized qualitatively by a transmission electron microscopy (TEM) technique using a Jeol 2000 FX microscope having an acceleration voltage of 200 kV. The samples were ground in the form of powder which was then deposited on a copper grid coated with a carbon Formvar&Commat membrane.

The specific surface areas and the characteristics of the pores on the micro(meso)scopic scale were quantified by mercury intrusion/extrusion measurements using a machine sold under the name Micromeritics Autopore IV, in order to obtain the characteristics of the macroscopic cells making up the backbone.

The specific surface area measurements were made by nitrogen adsorption-desorption techniques using a machine sold under the name Micromeritics ASAP 2010; the analysis being carried out by BET or BJH calculation methods.

The samples were then subjected to an X-ray diffraction (XRD) analysis using a D8 Advance diffractometer sold by Bruker (Cu anode, K_{α} radiation, λ=1.54056 Å) equipped with a PSD detector. Due to the high reactivity of LiBH₄ with respect to air and moisture, a hermetically sealed sample holder equipped with a is beryllium window was used. This device is responsible for the presence of reflections corresponding to metallic Be in the X-ray diffractograms.

Calorimeter analyses were carried out under a stream of argon (100 cm³·min⁻¹) with the aid of a differential scanning calorimeter sold under the reference DSC 204 by Netzsch, using stainless steel crucibles sealed by a cover, the latter being perforated just before the analysis so as to enable hydrogen to escape under the influence of the heating. A heating rate of 2° C./min was used in all the experiments.

Temperature-programmed desorption (TPD) measurements coupled with mass spectrometry were carried out on LiBH₄, and also on monoliths loaded with LiBH₄ in accordance with the invention, using a mass spectrophotometer sold under the reference QXK300 by VG Scientific Ltd. The procedure consists in loading around 5 mg of monolith into a stainless steel tube (6 mm in diameter). The tube is then connected to the mass spectrophotometer and degassed under low vacuum (10⁻² mbar). The TPD curves (m/z=2 for hydrogen) were acquired by applying a temperature increase rate of 10° C./min until 600° C. is reached. The desorption of the hydrogen was monitored by volumetric measurements using a Sieverts-type apparatus (R. Checchetto et al., Meas. Sci. Technol., 2004, 15, 127-130). After degassing at ambient temperature, the hydrogen absorption/desorption properties of the samples tested were calculated by volumetric measurement using the ideal gas law. The hydrogen desorption capacity of the samples was measured every 50° C. between 50° C. and 500° C. For each temperature, the measurement of the hydrogen desorption capacity was determined after a total desorption time of 2 hours. The calibrated volume, in which the hydrogen was collected, was regularly emptied so as to maintain a pressure always less than 1 bar. The samples were rehydrogenated under a pressure of 100 bar of hydrogen at 400° C. over 12 hours. The ¹¹B NMR spectra were determined by magic angle spinning of the samples (Magic Angle Spinning NMR: MAS NMR), at B₀=11.75 T, using an NMR spectrophotometer sold under the brand name Bruker Avance 500 Wide-Bore, operating at 128.28 MHz equipped with a 4 mm Bruker probe and adjusting the spinning rate of the rotor to 14 kHz. The spectra were acquired using a θ-σ-2θ spin echo sequence with θ=90. The period τ was synchronized with the spin frequency and a recycle period of 1 s was used. The chemical shifts were referenced relative to the compound BF₃(OEt)₂ (δ=0 ppm).

### Example 1

### Preparation of Composite Carbon Monoliths Comprising Palladium or Gold Nanoparticles

In this example, the preparation of various carbon monoliths comprising palladium or gold nanoparticles is illustrated.

1) First step: Synthesis of a microporous/mesoporous/macroporous silica monolith (MSi).

5 g of TEOS were added to 16 g of an aqueous 35% TTAB solution pre-acidified with 6 g of HCl. The mixture was left to hydrolyze until a single-phase hydrophilic medium (aqueous phase of the emulsion) was obtained. Next, this aqueous phase was transferred to a mortar, then 35 g of dodecane (oily phase of the emulsion) were added dropwise and with stirring. Next, this emulsion was transferred to sealed polystyrene test tubes, then the emulsion was left to condense in the form of a silica monolith for a week at ambient temperature. The silica monoliths thus synthesized were then washed three times for 24 hours with a THF/acetone (50/50: v/v) mixture in order to extract the oily phase therefrom. The silica monoliths were then dried for one week at ambient temperature, then they were subjected to a heat treatment at 650° C. for 6 hours, applying a temperature increase rate of 2° C/min., with a first hold at 200° C. for 2 hours. Silica monoliths denoted MSi were obtained.

2) Second Step: Impregnation of Silica Monolith with Phenolic Resin

A solution of 25% by weight of Ablaphenet RS 110 phenolic resin in THF was prepared, referred to as Solution S25.

The MSi silica monoliths obtained above were immersed in the Solution S25 in a beaker. The beakers were placed under dynamic vacuum until the effervescence disappeared in order to ensure good impregnation of the silica matrices with the phenolic resin solutions, then left under static vacuum for 3 days.

The silica monoliths thus impregnated with the Solution S25 (referred to as MSiS25) were then washed rapidly with TI-IF and then dried in an oven at a temperature of 80° C. for 24 hours in order to facilitate the evaporation of the solvent and to thermally initiate the crosslinking of the monomers of the phenolic resin. The MSiS25 monoliths were then subjected to a second heat treatment in a hot-air oven, at 155° C. for 5 hours, with a temperature increase rate of 2° C./min., carrying out a first hold at 80° C. for 12 hours then a second hold at 110° C. for 3 hours. The monoliths were then left to return to ambient temperature by simply turning off the oven. The monoliths were then washed with 10% hydrofluoric acid in order to eliminate the silica template, then rinsed copiously with distilled water is for 24 hours.

The graphitized carbon monoliths thus obtained were denoted by MS25carb.

3) Third Step: Impregnation of Carbon Monoliths with a Palladium Salt or a Gold Salt and Formation of Nanoparticles by Heterogeneous Nucleation

3.1 Preparation of Composite Monoliths Comprising Palladium Nanoparticles

MS25carb monoliths obtained above in the preceding step were immersed in a beaker containing a 4.5×10⁻²M solution of palladium chloride in an acetone/water (1/1: v/v) mixture acidified with 0.5 ml of hydrochloric acid. The beaker was then placed under dynamic vacuum until the effervescence disappeared in order to ensure good impregnation of the palladium chloride solution in the porosity of the monoliths, then left under static vacuum for 3 days. The monoliths were then dried in air, then the palladium chloride was reduced by heat treatment of the monoliths at 400° C. (temperature increase rate of 2° C./min) under hydrogen. The composite monoliths thus obtained were referred to as PdMS25carb.

3.2 Preparation of Composite Monoliths Comprising Gold Nanoparticles

MS25carb monoliths obtained above in the preceding step were immersed in a beaker containing a 4.5×10⁻² M solution of potassium tetrachloroaurate in an acetone/water (1/1: v/v) mixture. The beaker was then placed under dynamic vacuum until the effervescence disappeared in order to ensure good impregnation of the potassium tetrachloroaurate solution in the porosity of the monoliths, then left under static vacuum for 3 days. The monoliths were then dried in air, then the Au³⁺ ions of the potassium tetrachloroaurate were reduced by heat treatment of the monoliths at 80° C. under a hydrogen pressure of 8 bar. The composite monoliths thus obtained were referred to as AuMS25carb.

4) Characterizations

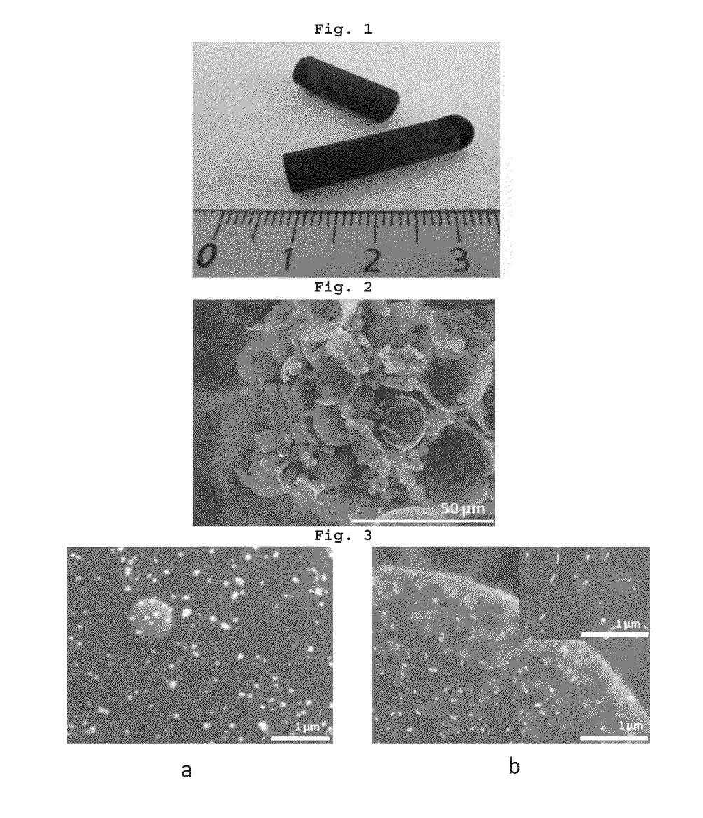

The appended FIG. 1 shows a macroscopic view of an MS25carb monolith obtained at the end of the second step of the process.

The appended FIG. 2 shows an SEM micrograph of the macroscopic porous network of the MS25carb carbon monolith from FIG. 1. In this figure, it is seen that the monolith comprises an open macroporosity, the texture of which resembles a cluster of hollow spheres.

After impregnation of the monoliths with the palladium or gold salts and reduction, the distribution of the palladium or gold nanoparticles was observed on the macroscopic scale with SEM by means of a backscattered electron detector (see appended FIG. 3). FIG. 3a corresponds to the PdMS25carb monolith and FIG. 3b to the AuMS25carb monolith. It is observed that the distribution of the metal nanoparticles is relatively homogeneous from the outside to the inside of the monolith with several clusters.

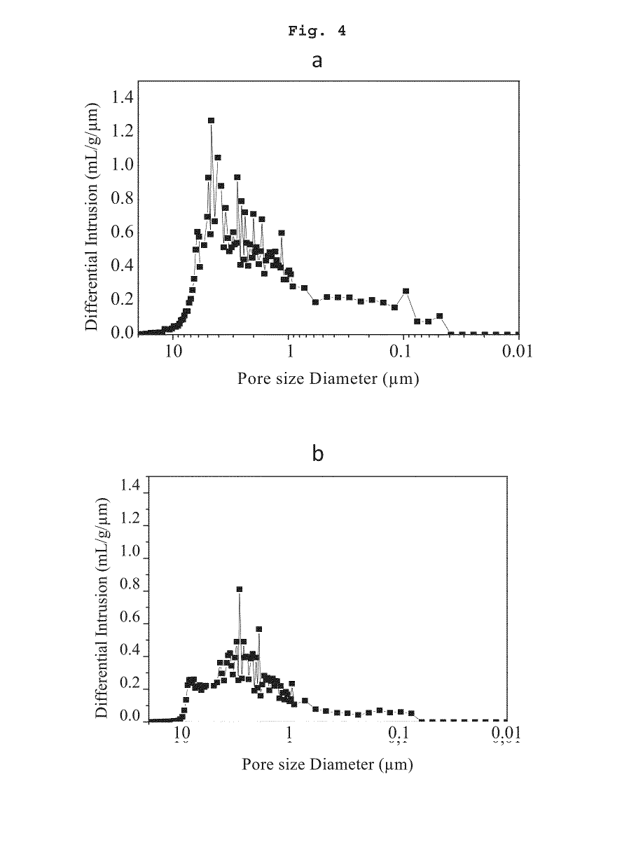

The results of the mercury intrusion measurements carried out on the PdMS25carb and AuMS25carb monoliths synthesized in this example are reported in appended FIG. 4. In these figures, the intrusion volume (in ml/g/μm) is a function of the diameter of the pores (in μm), FIG. 4a corresponding to the PdMS25carb monolith and FIG. 4b to the AuMS25carb monolith. It is important to emphasize here that the mercury intrusion measurements only make it possible to determine the diameter of the openings that connect two adjacent hollow spheres and not the diameter of the hollow spheres themselves. It is observed that the diameter of these openings is polydisperse and has a bimodal distribution. These characteristics result from the clustering of hollow spheres and denote the coexistence of internal and external cell junctions, the values greater than 1 μm corresponding to the external junctions and the values less than 100 nm corresponding to the internal junctions. The mercury intrusion measurements also made it possible to determine the percentage of porosity of the monoliths, and also the overall density and the density of the backbone of the monolith. The corresponding results are assembled in Table 1 below:

TABLE 1

| Monoliths | PdMS25carb | AuMS25carb |
|---|---|---|
| Intrusion volume (cm³ · g⁻¹) | 4.51 | 2.43 |
| Porosity (%) | 78 | 68 |
| Overall density (g · cm³) | 0.17 | 0.28 |
| Density of the backbone (g · cm³) | 0.81 | 0.87 |

Regarding the mesoscopic scale, the specific surface areas calculated from the nitrogen physisorption measurements are reported in Table 2 below:

TABLE 2

| | BET | BJH (m² · g⁻¹) | | t-Plot (m² · g⁻¹) | |
|---|---|---|---|---|---|
| | (m² · g⁻¹) | Adsorption | Desorption | Ext | Meso/Micro |
| PdMS25carb | 606 | 37 | 88 | 33 | 573 |
| AuMS25carb | 122 | 7 | | | 118 |

It appears that the specific surface area of the monolith comprising gold nanoparticles is lower than that of the monolith comprising palladium nanoparticles. With reference to FIG. 2, it turns out that the gold nanoparticles are smaller than the palladium nanoparticles and therefore are distributed more homogeneously at the surface of the macropores. This has the effect of minimizing the diffusion of nitrogen through the porosity. It is also important to recall that the porosity is expressed in m²·g⁻¹, i.e. for a same intrinsic porosity, the monolith comprising the most metal nanoparticles will intrinsically have a lower specific surface area. Furthermore, in accordance with the BJH values, it should be noted that the monoliths prepared in this way have no mesoporous network.

Elemental analyses of the PdMS25carb and AuMS25carb monoliths indicate that they contain 8.15% palladium and 10.07% gold respectively.

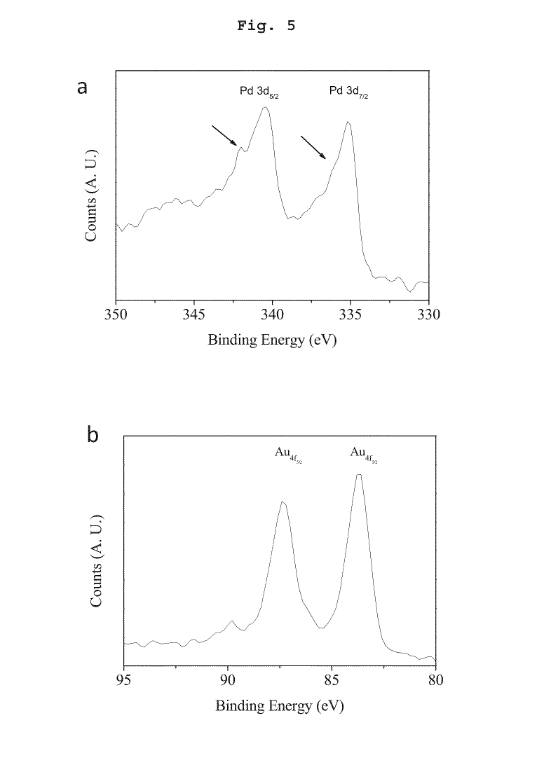

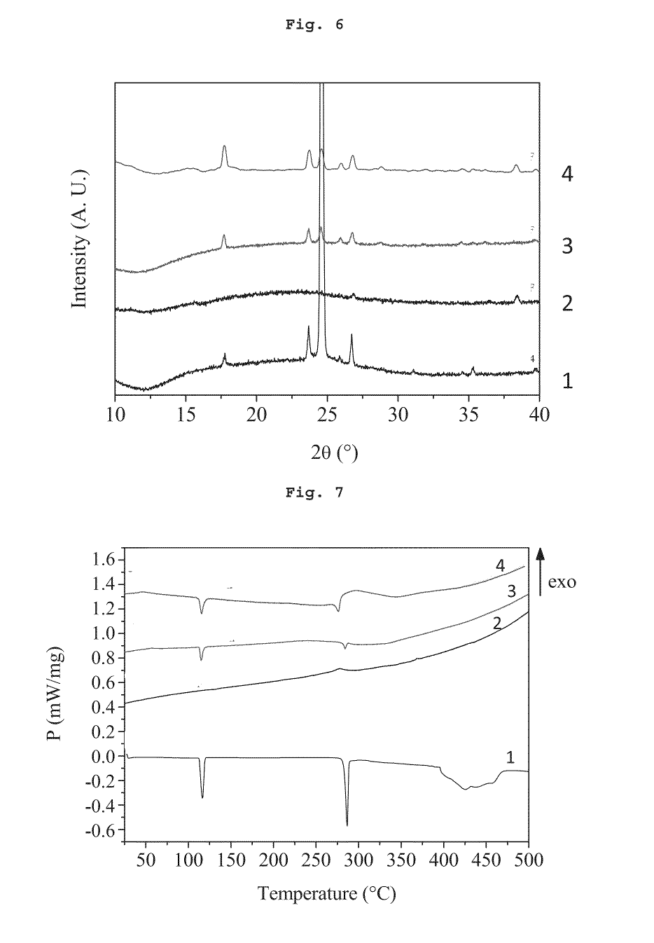

The XPS spectra of the PdMS25carb and AuMS25carb monoliths are given in appended FIG. 5 in which the binding energy (in eV) is a function of the number of counts (in arbitrary units: AU); FIG. 5a corresponding to the PdMS25carb monolith based on the binding energy of the metallic palladium and FIG. 5b corresponding to the AuMS25carb monolith based on the binding energy of the metallic gold. The spectrum from FIG. 5a shows the peaks of the Pd 3d_{5/2} at 340.3 eV and of the Pd 3d_{7/2} at 335.5 eV corresponding to the metallic palladium, that is to say to the palladium in the zero oxidation state. It is also possible to observe a slight shoulder indicated by the arrows on each of the peaks at a slightly higher binding energy value, said shoulder being attributed to the presence of a small amount of palladium oxide PdO, this amount being however too low to affect the performance of the monolith with respect to the subsequent storage of hydrogen.

In FIG. 5b the peaks of metallic gold 4F_{7/2} and 4F_{5/2} at 83.6 eV and 87.5 eV respectively are observed, these peaks signifying a complete reduction of the gold present in the monolith to the zero oxidation state.

### Example 2

### Hydrogen Storage in and Release from the Monoliths in Accordance with the Invention

The PdMS25carb and AuMS25carb carbon monoliths prepared above in Example 1 were used to store hydrogen, by heterogeneous nucleation of LiBH₄ within the micropores. The release of hydrogen from the carbon monoliths was also studied.

1) Storage of Hydrogen by Heterogeneous Nucleation of LiBH₄

All the experiments on the heterogeneous nucleation of LiBH₄ in the PdMS25carb and AuMS25carb carbon monoliths were carried out in a glove box under a purified argon atmosphere. A 0.1 M LiBH₄ solution was firstly prepared by dissolving 217 mg of LiBH₄ powder in 100 ml of MTBE at ambient temperature and with stirring. The carbon monoliths were degassed at 300° C. under high vacuum (P<10⁻⁴ mbar) for 12 hours before being impregnated with the LiBH₄ solution. The impregnation was carried out by placing 100 mg of each of the carbon monoliths in the 0.1 M LiBH₄ solution. After impregnation, the carbon monoliths were extracted from the LiBH₄ solution by filtration and dried under low vacuum at ambient temperature. Three impregnation/drying cycles were thus carried out in order to optimize the amount of LiBH₄ contained in the monoliths.

Carbon monoliths loaded with 20% by weight of solid LiBH₄ were thus obtained, respectively referred to as PdMS25carb/LiBH₄ and AuMS25carb/LiBH₄.

The amount of LiBH₄ loaded in the monoliths was determined by measuring the Li content by atomic absorption spectroscopy (AAS) on a spectrometer sold under the brand name AAnalyst 300 by PerkinElmer, after dissolving LiBH₄-loaded monoliths in a 1.0 M hydrochloric acid solution. Typically, 50 mg of LiBH₄—loaded monolith are introduced into a flask containing 250 cm³ of 0.1 M HCl solution, then the flask is placed in an ultrasonic tank for a duration of 30 minutes. The solution obtained is assayed by atomic absorption spectroscopy. Standard solutions containing 1, 2 and 3 mg·L⁻¹ of Li were used beforehand to calibrate the spectrometer.

All the hydrogen contents given in this example are expressed as percentage by weight relative to the total weight of the sample (LiBH₄+carbon monolith).

2) Results Relating to the Desorstion of Dihydrogen

Appended FIG. 6 represents the X-ray diffractograms of the PdMS25carb/LiBH₄ and AuMS25carb/LiBH₄ monoliths (respectively curves 4 and 3), and also that of a carbon monolith not modified by metal nano⁻particles (MS25carb/LiBH₄; curve 2) and of commercial LIB II₄ alone (curve 1).

For the LiBH₄ alone, clearly defined diffraction peaks are observed that correspond to the low-temperature orthorhombic unit cell of LiBH₄ (Pnma space group): the very sharp reflections reveal large-size crystallites and the reflection 002 at 2θ_{Cu}=24.6° is abnormally intense, probably due to a preferential orientation. A significant loss of the crystalline nature of the LiBH₄ is also observed after its heterogeneous nucleation on the walls of the macropores (curve 2), the presence of the micropores at the surface of the macropores optimizing the heterogeneous nucleation phenomenon while minimizing the growth of the LiBH₄ and also its crystalline nature. On the other hand, the diffraction peaks of the LiBH₄ are clearly present in curves 3 and 4 corresponding respectively to the AuMS25carb/LiBH₄ and PdMS25carb/LiBH₄ monoliths. This signifies that the metal nanoparticles present in these monoliths promote the crystallization of the LiBH₄ and reduce the negative influence of the micropores present at the surface of the macropores. This probably stems from the fact that the carbon-containing walls and the metal nanoparticles have different surface energies and consequently a wettability that is lower than those of the metal nanoparticles with respect to the LiBH₄ solution used for impregnating the monoliths. The heterogeneous nucleation of the LiBH₄ at the surface of the metal nanoparticles is thus promoted and as there are fewer nanoparticles present at the surface of the macropores than at the surface of the micropores, the nucleation of the LiBH₄ will he minimized whereas the crystalline growth will on the contrary itself be increased and optimized so as to consume all of the LiBH₄ precursor present in the impregnation solution.

The loss of crystallinity of LiBH₄ in the MS25carb/LiBH₄ monolith was confirmed by DSC. The results corresponding to the thermal decomposition of the samples tested are presented in the appended FIG. 7 in which the heat flux (in mW/mg) is a function of the temperature (in ° C.). In this figure, curve 1 corresponds to the LiBH₄ alone, curve 2 to the carbon monolith loaded with LiBH₄ (MS25carb/LiB curve 3 to the AuMS25carb/LiBH₄ monolith and curve 4 to the PdMS25carb/LiBH₄ monolith.

For the LiBH₄ alone, two sharp endothermic peaks are observed at 116° C. and 286° C. and a relatively broad depression is observed between 400 and 450° C. The first endothermic peak at 116° C. indicates that LiBH₄ undergoes a phase transition in order to pass from the low-temperature orthorhombic unit cell (Puma) to a high-temperature phase (P6₃mc) (Soulié, J.-P; et al., J. All. Comp., 2002, 346, 200). The second endothermic peak located at 286° C. corresponds to the melting of LiBH₄. According to literature, it is known that the desorption of hydrogen from LiBH₄ in powder form, i.e. not contained in a carbon monolith as used according to the present invention, takes place in 2 steps at a temperature above the melting point (via the formation of an intermediate decomposition product: Li₂B₁₂H₁₂ that may be contaminated by the release of volatile species such as diborane (B₂H₆); Orimo, S. et al., Appl. Phys. Let., 2006, 89, 219201). At 500° C., the decomposition is products of LiBH₄ are LiH and boron.

With the MS25carb/LiBH₄ monolith, the shape of the curve is modified drastically since no phase transition peak is observed. This is in agreement with the absence of reflection observed on the X-ray diffractogram presented in FIG. 6. In so far as the presence of BH₄ was confirmed by ¹¹B NMR, it is possible to conclude therefrom that the LiBH₄ is present in the form of an amorphous phase. Very surprisingly, no endothermic peak for release of dihydrogen is observed. Conversely, a small exothermic peak is observed that may be explained by the presence of oxygenated residual groups in the microporosity of the monoliths giving rise to irreversible and exothermic reactions that result in the formation of borates (presence of peaks between 5 and 200 ppm in ¹¹B NMR that may be attributed to BO₄ and/or BO₃). Indeed, even though the carbon monoliths were degassed under high vacuum at 300° C. for 12 hours before the impregnation steps, it is very difficult to ensure that the porosity of the monoliths is completely free of residual chemical groups that could create parasitic reactions during the release of dihydrogen from LiBH₄.

On the other hand, in the case of monoliths comprising metal nanoparticles, namely the AuMS25carb/LiBH₄ and PdMS25carb/LiBH₄ monoliths in accordance with the invention, no modification of the appearance of the curves is observed compared to LiBH₄ alone, the characteristic peaks of the phase transition of LiBH₄ and of the melting thereof indeed being observed at the same temperatures. The release of dihydrogen appears to be slightly endothermic, suggesting the absence of oxidation reaction during the process.

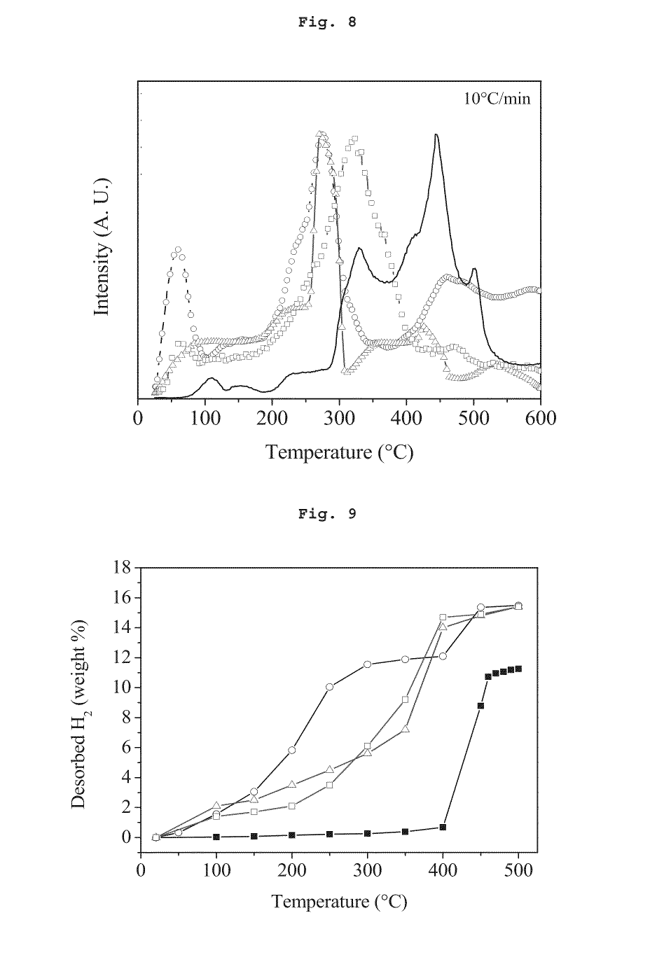

The hydrogen desorption properties of the various samples tested are presented in appended FIG. 8 which represents the dihydrogen emission curves measured by thermal desorption coupled to the mass spectrometer on the various samples. In this figure, the intensity of the peak m/z=2 (in AU) is a function of the temperature (in ° C.), the curve with the continuous line without symbols corresponds to the dihydrogen emission measured on LiBH₄ alone, the curve with the line interrupted by open circles corresponds to the dihydrogen emission measured on the MS25carb/LiBH₄ monolith not in accordance with the invention, the curve with the line interrupted by open squares corresponds to the dihydrogen to emission measured on the AuMS25carb/LiBH₄ monolith in accordance with the invention and the curve with the line interrupted by open triangles corresponds to the dihydrogen emission measured on the PdMS25carb/LiBH₄ monolith in accordance with the invention.

It is observed that with LiBH₄ alone, the desorption of the dihydrogen takes is place at a temperature above 300° C. in several steps, the main desorption peak being centred at 445° C. When LiBH₄ is nucleated in a carbon monolith not in accordance with the invention, i.e. not comprising metal nanoparticles (MS25carb/LiBH₄ monolith), a single sharp dihydrogen desorption peak is observed, centred at 275° C. a temperature which is approximately 170° C. lower than that needed for the desorption of dihydrogen from LiBH₄ alone. In addition to this main peak at 276° C., a secondary peak is observed at 60° C. The presence of this additional peak may be attributed to the thermal decomposition of LiBH₄₋ₓ(OH), phases, resulting from the reaction of LiBH₄ with moisture (Hwang, S-J. et al., J. Phys. Chem. C, 2008, 112, 3165) leading to the formation of dihydrogen and borates at low temperatures.

In comparison, the dihydrogen desorption peak observed at 60° C. with the PdMS25carb/LiBH₄ and AuMS25carb/LiBH₄ monoliths in accordance with the invention are smaller, suggesting a reduced oxidation. As regards the PdMS25carb/LiBH₄ monolith, the main dihydrogen desorption peak is centred at 275° C. and is sharper than the corresponding peak observed for MS25carb/LiBH₄ monolith that has no metal nanoparticles. Furthermore, an additional desorption is observed at a temperature below 350° C., which may correspond to the decomposition of LiH.

FIG. 9 represents the dihydrogen emission curves obtained by volumetric measurements according to the Sievert method for each of the samples tested. In this figure, the amount of desorbed hydrogen (in weight % relative to the LiBH₄) is a function of the temperature (in ° C.); the curve with the solid squares corresponds to the dihydrogen emission measured from LiBH₄ alone, the curve with the open circles corresponds to the dihydrogen emission measured from the MS25carb/LiBH₄ monolith that has no metal nanoparticles, the curve with the open squares corresponds to the AuMS25carb/LiBH₄ monolith in accordance with the invention and the curve with the open triangles corresponds to the PdMS25carb/LiBH₄ monolith in accordance with the invention. The values of weight % of desorbed hydrogen given in FIG. 9 must be divided by 5 in order to have weight % of desorbed hydrogen relative to the total weight of the materials (including the weight of the matrix of the carbon monoliths and that of the metal to nanoparticles where appropriate).

For the LiBH₄ alone, the dehydrogenation takes place at 400° C. and reaches 11.2% by weight at 500° C., which corresponds to 81% of the theoretical capacity on the basis of the formation of LiH and B (theoretical dehydrogenation weight % of 13.8%). With the MS25carb/LiBH₄ monolith that has no metal nanoparticles, the dehydrogenation begins at 100° C. At 300° C., 11.6% by weight of dihydrogen is desorbed whereas the weight % of desorbed dihydrogen for the LiBH₄ alone is negligible at this same temperature, a 2^{nd} then being observed at temperatures above 400° C. to reach a final weight % of dihydrogen desorption of 16% at 500° C., which represents 3.4 hydrogen atoms per unit of formula LiBH₄. The same behaviour is observed with the PdMS25carb/LiBH₄ and AuMS25carb/LiBH₄ monoliths in accordance with the invention, with however amounts of desorbed dihydrogen slightly lower than that observed with the MS25carb/LiBH₄ monolith at temperatures below 350° C. At temperatures above 350° C., the curves join together to reach a final weight % of the release of dihydrogen of 15.6% by weight at 500° C.

3) Monolith Rehydrogenation Tests

The various monoliths tested above (PdMS25carb/LiBH₄; AuMS25carb/LiBH₄ and MS25carb/LiBH₄) and LiBH₄ alone were then subjected to a pressure of 100 bar of H₂ at 400° C. for 12 hours with a view to being rehydrogenated.

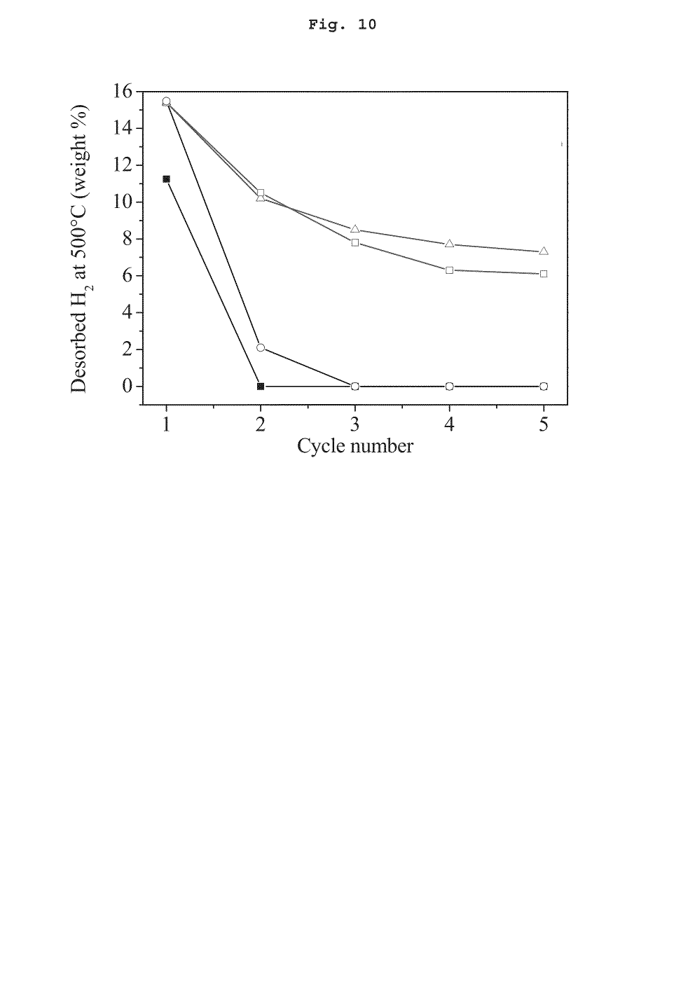

Appended FIG. 10 shows the amount of hydrogen released at 500° C. weight %) as a function of the number of cycles for the first 5 desorption/absorption cycles. In this figure, the curve with the solid squares corresponds to the LiBH₄ alone, the curve with the open circles corresponds to the MS25carb/LiBH₄ monolith not in accordance with the invention, the curve with the open squares corresponds to the AuMS25carb/LiBH₄ monolith in accordance with the invention and the curve with the open triangles corresponds to the PdMS25carb/LiBH₄ monolith in accordance with the invention.

These results show that the rehydrogenation of the LiBH₄ is impossible in so far as no release of dihydrogen is observed from the 2^{nd} desorption cycle. A positive effect of confining LiBH₄ in the MS25carb/LiBH₄ monolith not in accordance with the invention is observed, for which a slight rehydrogenation of the monolith is observed. This is confirmed by the level of release of dihydrogen (2.1% by weight relative to the weight of LiBH₄) in the 2^{nd} desorption cycle.

On the other hand, with the monoliths in accordance with the invention, i.e. comprising inclusions of metal nanoparticles, a very significant increase in the amount of dihydrogen that can be reabsorbed is observed. Indeed, approximately 10.4% by weight of dihydrogen is released during the 2^{nd} cycle both with the AuMS25carb/LiBH₄ monolith and with the PdMS25carb/LiBH₄ monolith. Thus, the existence of a reversible phenomenon is demonstrated, the dihydrogen retention capacity of the PdMS25carb/LiBH₄ monolith being slightly greater than that of the AuMS25carb/LiBH₄ monolith. After 5 desorption/reabsorption cycles, the AuMS25carb/LiBH₄ monolith still makes it possible to release 7.4% by weight of dihydrogen, which corresponds to 48% of the capacity obtained during the first desorption.

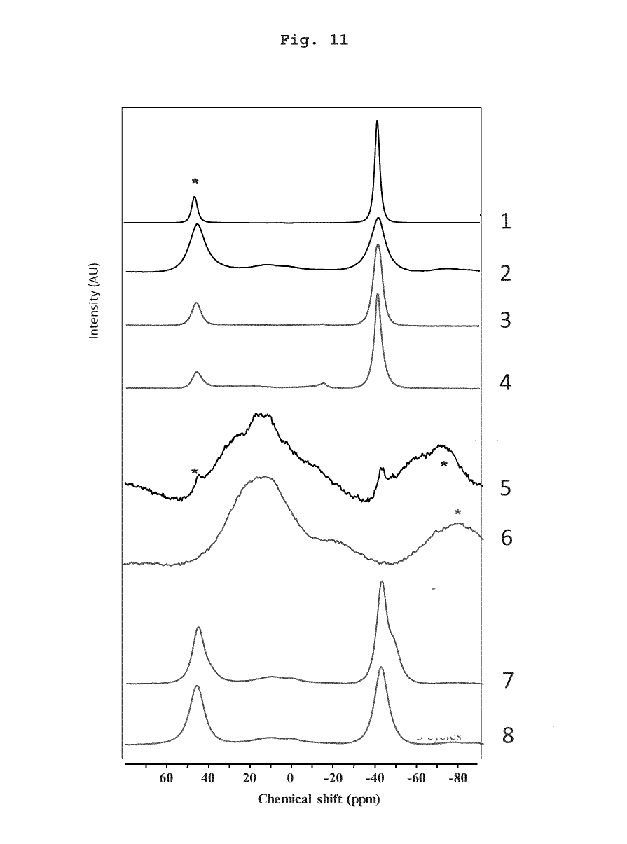

These results have been confirmed by ¹¹B NMR. Appended FIG. 11 reports the results obtained with the various samples tested, the chemical shift (in ppm) being a function of the intensity (in AU). In this figure, the correlations between the samples tested and the numbers of the curves are the following:
Curve 1: LiBH₄ alone,
Curve 2: MS25carb/LiBH₄ monolith as prepared,
Curve 3: PdMS25carb/LiBH₄ monolith as prepared,
Curve 4: AuMS25carb/LiBH₄ monolith as prepared,
Curve 5: MS25carb/LiBH₄ monolith after 1 desorption/absorption cycle,
Curve 6: PdMS25carb/LiBH₄ monolith after 1 desorption/absorption cycle,
Curve 7: AuMS25carb/LiBH₄ monolith after 1 desorption/absorption cycle,
Curve 8: PdMS25carb/LiBH₄ monolith after 5 desorption/absorption cycles,
Curve 9: AuMS25carb/LiBH₄ monolith after 5 desorption/absorption cycles.

In this figure, it can be seen that all the materials as prepared have a signal at −41 ppm, characteristic of the BH₄ environment in the LiBH₄. This signal is significantly broader in the case of the MS25carb/LiBH₄ monolith compared to the PdMS25carb/LiBH₄ and AuMS25carb/LiBH₄ monoliths and to LiBH₄ alone, indicating a greater reduction in the crystalline nature when the monolith is free of metal nanoparticles, which is in agreement with the X-ray diffraction results presented in FIG. 6. The small additional signal observed at the positive values of the chemical shift for the MS25carb/LiBH₄ monolith and previously attributed to the presence of B—O bonds (due to the interaction of LiBH₄ with reactive functional groups such as —COOH, —OH, present in the microporosity of the carbon and/or with residual moisture) is not observed in the PdMS25carb/LiBH₄ and AuMS25carb/LiBH₄ monoliths. This confirms the reduced oxidation of the LiBH₄ in the monoliths in accordance with the invention, i.e. comprising metal nanoparticles, as suggested previously by the hydrogen desorption curves obtained in mass spectrophotometry, (FIG. 8). Consequently, it is obvious that the presence of these metal nanoparticles improves the rehydrogenation process and promotes the formation of a BH₄-type environment. The nanoparticles promote the heterogeneous nucleation and the growth of the LiBH₄ crystals. During the dehydrogenation/rehydrogenation cycles, the metal nanoparticles, owing to their greater capacity to absorb heat than the carbon-based backbone, offer nanospots having a higher temperature than the carbon-based surface over which the rehydrogenation kinetics are certainly improved.

Still with respect to FIG. 11, and after the first dehydrogenation/rehydrogenation cycle, a broad signal ranging from −20 to 40 ppm is observed for the MS25carb/LiBH₄ monolith without metal nanoparticles corresponding to amorphous elemental boron, confirming the very low rehydrogenation of the material. Additional signals are also observed at 5 and 20 ppm that may be attributed to the presence of BO₄ and BO₃ signifying the formation of borates, the stability of which prohibits reduction by hydrogen. Due to the chemical inertia of boron and the concomitant formation of borates, the amount of LiBH₄ present after the first dehydrogenation/rehydrogenation cycle is low (only 2.1% by weight of dihydrogen is released during the 2^{nd} desorption, cf. FIG. 10). This is confirmed by the very weak intensity of the peak at −41 ppm on the ¹¹B NMR spectrum. On the other hand, after 5 dehydrogenation/rehydrogenation cycles, the ¹¹B NMR spectra of the PdMS25carb/LiBH₄ and AuMS25carb/LiBH₄ monoliths in accordance with the invention give a large signal at −41 ppm, characteristic of the presence of BH₄, confirming that the hydrogen recombines with the boron and that the process for storing hydrogen in the monoliths of the invention is indeed reversible. A very small shoulder is however observed between −10 and 20 ppm corresponding to a very small amount of boron that does not react with the hydrogen and which shows that process is not completely reversible. The fact remains that the rehydrogenation performance of the monoliths in accordance with the present invention is very significantly greater than that of the MS25carb/LiBH₄ monolith having no inclusion of metal nanopartictes.

All of these results demonstrate that the presence of metal nanoparticles in the carbon monoliths makes it possible to reduce the formation of borates, which may be explained by the fact that the heterogeneous nucleation of the LiBH₄ takes place preferentially on the metal nanoparticles. This particular configuration, which reduces the oxidation of the boron during the dehydrogenation process, combined with the intrinsic capacity of the metal nanoparticles to absorb heat (the metal nanoparticles acting as high-temperature nanospots), makes it possible to greatly improve the rehydrogenation process, thus making it possible to attain a reversible hydrogen storage process at 400° C.

1. Cellular solid composite material that is in the form of a porous carbon monolith comprising:
a hierarchized porous network having macropores having a mean size d_{A} of 1 μm to 100 μm and micropores having a mean size d₁ of 0.7 to 1.5 nm, said macropores and micropores being interconnected, said material having mesoporous network and and wherein said cellular solid composite material has nanoparticles of a metal M in the zero oxidation state, said metal M being selected from palladium and gold.

2. Material according to claim 1, wherein the nanoparticles of palladium or gold are present at the surface of the macropores of the monolith.

3. Material according to claim 1, wherein the size of the nanoparticles of metal M varies from 1 to 300 nm.

4. Process for preparing a composite material as defined in claim 1 said process further comprising the following steps:
i) a step of impregnating a porous carbon monolith comprising a hierarchized porous network comprising macropores having a mean size d_{A} of 1 μm to 100 μm and micropores having a mean size d₁ of 0.7 to 1.5 nm, said macropores and micropores being interconnected, said material having no mesoporous network, with a solution of a salt of a metal M selected from palladium and gold in a solvent;
ii) a step of air drying said monolith;
iii) a step of forming nanoparticles of said metal M in the zero oxidation state by heat treatment of said monolith at a temperature varying from 50 to 900° C., in the presence of a reducing gas, in order to reduce the metal ions M to the zero oxidation state.

5. Process according to claim 4, wherein the salt of a metal M is selected from palladium chloride, potassium tetrachloroaurate and hydrogen tetrachloroaurate.

6. Process according to claim 4, wherein the concentration of metal M salt within the impregnation solution varies from 10⁻³ M to 1 M.

7. Process according to claims 4, wherein the heat treatment of step iii) is carried out in the presence of hydrogen at a temperature of 400° C. for 1 hour.

8. Process for storing hydrogen in a composite material having nanoparticles of a metal M selected from palladium and gold in the zero oxidation state and as defined in claim 1, said process at comprising least the following steps:
a) a step of degassing said material under high vacuum and at a temperature of 150 to 400° C.;
b) a step of impregnating, at ambient temperature, said degassed material with a solution of at least one metal hydride of formula (I) X(BH₄)ₙ with X=Li, Na, Mg or K, and n=1 when X=Li, Na or K and n=2 when X=Mg, in solution in an organic solvent selected from ethers;
c) a step of drying the material impregnated with the metal hydride solution, said drying being carried out under low vacuum and at ambient temperature; and optionally
d) the repetition, one or more times, of steps b) and c) above.

9. Process according to claim 8, wherein the degassing of the material during step a) is carried out at a temperature of 280 to 320° C.

10. Process according to claim 8, wherein the metal hydride of formula (I) is lithium borohydride.

11. Process according to claim wherein the solvent of the metal hydride solution is methyl tert-butyl ether.

12. Composite material that is in the storm of a porous carbon monolith having a hierarchized porous network comprising macropores having a mean size d_{A} of 1 μm to 100 μm approximately and micropores having a mean size d₁ of 0.7 to 1.5 nm, said macropores and micropores being interconnected, said material having no mesoporous network, said composite material comprising:
nanoparticles of a metal M in the zero oxidation state, said metal M being selected from palladium and gold, and in that the micropores contain hydrogen in the form of a crystalline, semicrystalline or amorphous metal hydride selected from the hydrides of formula (I) X(BH₄)ₙ with X=Li, Na, Mg or K, and n=1 when X=Li, Na or K and n=2 when X=Mg.

13. Composite material according to claim 12, wherein said site material's specific surface area is from 50 to 900 m²/g.

14. Composite material according to claim 12, wherein the volume of the micropores is greater than or equal to 0.30 cm³·g⁻¹ of composite monolith and in that the metal hydride is in amorphous form.

15. Composite material as defined in claim 12, wherein said composite material is suitable for the production of dihydrogen.

16. Composite material as defined in claim 15, wherein said composite material is suitable for supplying dihydrogen to a fuel cell operating with dihydrogen.

17. Composite material as defined in claim 12, wherein said composite material is subjected to a heating step at a temperature of at least 100° C. as part of said Dihydrogen production process.

18. Composite material according to claim 17, wherein the heating step is carried out at a temperature of 250 to 400° C.

19. Reversible dihydrogen production process, comprising at least the following steps:
1) a dihydrogen production step during which a composite material as defined in claim 12 is subjected to a heating step at a temperature of at least 100° C., then
2) a rehydrogenation step during which said composite material is subjected to a hydrogen pressure of 50 to 200 bar at a temperature of 200 to 500° C. for 1 to 48 hours; and
3) the repetition of steps 1) and 2) above one or more times.

20. Process according to claim 19, wherein step 2) is carried out by subjecting the material to a hydrogen pressure of 100 bar at 400° C. for 12 to 24 hours.
